(19) United States
(12) Patent Application Publication
(10) Pub. No.: US 2011/0316974 A1
(43) Pub. Date: Dec. 29, 2011

(54) METHOD AND SYSTEM FOR REDUCING GHOST IMAGES OF THREE-DIMENSIONAL IMAGES

(75) Inventors: MENG-CHAO KAO, Taipei City (TW); CHUN-CHIEH CHIU, Luzhu Township (TW)

(73) Assignee: CHUNGHWA PICTURE TUBES, LTD.,, Bade City (TW)

(21) Appl. No.: 12/870,822

(22) Filed: Aug. 29, 2010

(30) Foreign Application Priority Data
Jun. 29, 2010 (TW) 099121321

(51) Int. Cl. H04N 13/02

(52) U.S. Cl. 348/46; 348/E13.074

(57) ABSTRACT

A method and system for reducing ghost images in three-dimensional (3D) images are disclosed. The method comprises: calculating a brightness difference distribution between a left-eye image and a right-eye image; determining a space factor indicating a brightness change resulting from the brightness difference distribution on the left-eye image or the right-eye image, the space factor being determined according to two-dimensional (2D) positions where the brightness difference distribution occurs on the screen; and multiplying the brightness difference distribution by the space factor to obtain a compensated right ghost brightness and a compensated left ghost brightness, and respectively deducting the compensated right ghost brightness and the compensated left ghost brightness from the left-eye image and the right-eye image.

### TECHNICAL FIELD OF THE INVENTION

The present invention relates to a method and a system for displaying three-dimensional (3D) images, and especially to a method and a system for reducing ghost images of the 3D images.

### BACKGROUD OF THE INVENTION

In recent years, three-dimensional (3D) glasses used in applications to view 3D images are becoming more common. Conventionally, 3D glasses can be divided into two types: polarized glasses and shutter glasses. FIG. 1 shows a schematic diagram illustrating scanning positions of images corresponding to timing sequence of shutter glasses in the prior art. More specifically, FIG. 1 illustrates a liquid crystal display (LCD) showing left-eye images and right-eye images being accompanied with the shutter glasses with a frame rate of 120 Hz frame-per-second (FPS). When the LCD screen 16 shows a left-eye image 10 in a progressive scanning mode, the gate lines 15 within the LCD screen 16 are sequentially scanned from top to bottom consuming 5.67 ms; meanwhile, the shutter glasses 11 cover both eyes. After the bottommost gate line 15 is scanned, the left-eye image 10 is updated completely. At this time, the shutter glasses 11 open the cover above the left eye and maintain such a state for 2.67 ms, so that the observer sees the left-eye image 10 from the left eye. After the aforesaid actions, the shutter glasses 11 cover the left eye (as well as the right eye) in a cycle of 8.43 ms (i.e., 1/120 seconds) to accomplish viewing of the left-eye image 10. Likewise, a viewing of the right-eye image 20 is similar as described above.

According to FIG. 1, the liquid crystals should reach a steady state before the shutter glasses 11 open the cover of the left eye or the right eye; since the LCD screen 16 is driven in the progressive scanning mode, the moments for the liquid crystals to reach steady state are different in various vertical positions of the LCD screen 16 thereof. However, in a conventional drive circuit, the aforesaid issue is not considered. Accordingly, when the 3D images are viewed, a previous left-eye image or right-eye image is easily viewed at the bottom of the screen due to the liquid crystals which have not yet completely reached the steady state. Such a phenomenon is referred to as a ghost image.

There have been improved methods in prior art, including an over driver (OD) method. An OD table is established and used in speeding up a transition for the liquid crystals in a middle region of the LCD screen more quickly reaching the steady state. The OD table is a table of plural driving voltages required to be added for changing the current grayscale values of pixels to desired grayscale values of the next image. However, establishing the OD table takes time, and an additional memory is needed for storing the table. Moreover, the OD method only improves the transition of the liquid crystals in the middle region of the LCD screen. The transition of the liquid crystals in a top region of the LCD screen is made too strong, while the transition of the liquid crystals in a bottom region of the LCD screen is made too weak. Therefore, the ghost images still remain and are unable to be effectively eliminated.

In addition to the above issues, there is also a drawback that a coverage percentage of the shutter glasses is insufficient. In a one-eye viewing, if the shutter glasses can not completely cover the other eye, it is easy to cause an overall light leakage. In the aforesaid situation, ghost images or crosstalk phenomenon (i.e. interactive light leakage) is also generated. Such a drawback can not be improved by using the OD method.

Therefore, it is desired to have a method and a system for reducing ghost images of 3D images to overcome the aforesaid drawbacks.

### SUMMARY OF THE INVENTION

Because of the aforementioned drawbacks, an objective of the present invention is to provide a method for reducing ghost images of 3D images to solve the drawback using the over-driven table with a limited effectiveness in the prior art.

Another objective of the present invention is to provide a system for reducing ghost images of 3D images, such that the ghost images can be deducted in advance before the impact on the screen for reducing the ghost images being generated, hence, increase viewing comfort.

To achieve the foregoing objectives, according to an aspect of the present invention, a method for reducing ghost images of 3D images is provided. The method for reducing ghost images of 3D images when observed from a screen together with shutter glasses, reducing a right-eye image observed by the left eye and a left-eye image observed by the right eye, comprises the steps of: using a first computing module to calculate a brightness difference distribution between the left-eye image and the right-eye image; using a space factor module to determine a space factor to indicate a brightness change resulting from the brightness difference distribution on the left-eye image or the right-eye image, the space factor being determined according to two-dimensional (2D) positions where the brightness difference distribution occurs on the screen; and using a second computing module to multiply the brightness difference distribution by the space factor to obtain a compensated right ghost brightness and a compensated left ghost brightness, and respectively deducting the compensated right ghost brightness and the compensated left ghost brightness from the left-eye image and the right-eye image.

In one preferred embodiment of the present invention, the method further comprises using a first conversion unit to pre-convert grayscale data of the left-eye image and the right-eye image into brightness data. In addition, the method further comprises using a second conversion unit to convert the brightness data of the deducted left-eye image and the deducted right-eye image into the grayscale data after deducting the compensated right ghost brightness and the compensated left ghost brightness from the left-eye image and the right-eye image respectively.

In the preferred embodiment of the present invention, the brightness difference distribution between the right-eye image and the right-eye image is a left ghost brightness which is a brightness of the right-eye image subtracted from a brightness of the left-eye image, and a right ghost brightness which is a brightness of the left-eye image subtracted from a brightness of the right-eye image.

In the preferred embodiment of the present invention, the space factor changes with a vertical direction of the screen, e.g. a linear variation. Furthermore, the space factor is a light leakage rate multiplying the linear variation between 0 and 1, among which the light leakage rate relates to characteristics of an LCD panel of the screen.

In accordance with the method for reducing ghost images of 3D images of the present invention, a negative signal of the compensating ghost images can be deducted in advance on the left-eye image and the right-eye image, thereby reducing the ghost images and solving the drawback of using the over-driven table with a limited effectiveness in the prior art, hence, improving the viewing comfort.

According to another aspect of the present invention, a system for reducing ghost images of 3D images is provided. The system for reducing ghost images of 3D images observed from a screen with shutter glasses, thereby reducing the left eye observing a right-eye image and the right eye observing a left-eye image, the system comprises a first computing module, space factor module, and second computing module.

The first computing module is utilized to calculate a brightness difference distribution between the left-eye image and the right-eye image. The space factor module, being electrically coupled to the first computing module, is utilized to determine a space factor representing a brightness change of the brightness difference distribution on the left-eye image or the right-eye image. The space factor is determined according to 2D positions of the brightness difference distribution on the screen. The second computing module, being electrically coupled to the first computing module and the space factor module, is utilized to calculate the brightness difference distribution multiplying the space factor for obtaining a compensated right ghost brightness and a compensated left ghost brightness, and deduct the compensated right ghost brightness and the compensated left ghost brightness from the left-eye image and the right-eye image respectively.

In one preferred embodiment of the present invention, the system further comprises a first conversion unit and a second conversion unit. The first conversion unit, being electrically coupled to the first computing module, is utilized to pre-convert grayscale data of the left-eye image and the right-eye image into brightness data. The second conversion unit, being electrically coupled to the second computing module, is utilized to convert the brightness data of the deducted left-eye image and the deducted right-eye image into the grayscale data.

In accordance with the system of the present invention for reducing ghost images of 3D images, the negative signal of the compensating ghost images can be deducted in advance from the left-eye image and the right-eye image, thereby countervailing the ghost images when actually viewing the 3D images for reducing effects of the ghost images and improving the viewing comfort.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic diagram illustrating scanning positions of images corresponding to timing sequence of shutter glasses in the prior art.

FIG. 2 is a flow chart illustrating a method for reducing ghost images of 3D images according to one preferred embodiment of the present invention.

FIG. 3 is a schematic diagram illustrating a relationship between grayscale data and brightness data.

FIG. 4a is a schematic diagram illustrating a left-eye brightness distribution corresponding to a left-eye image according to one preferred embodiment of the present invention.

FIG. 4b is a schematic diagram illustrating a right-eye brightness distribution corresponding to a right-eye image according to one preferred embodiment of the present invention.

FIG. 5a is a schematic diagram illustrating a right ghost brightness distribution according to one preferred embodiment of the present invention.

FIG. 5b is a schematic diagram illustrating a left ghost brightness distribution according to one preferred embodiment of the present invention.

FIG. 6a is a schematic diagram illustrating calculating a compensated right ghost brightness distribution according to one preferred embodiment of the present invention.

FIG. 6b is a schematic diagram illustrating calculating a compensated left ghost brightness distribution according to one preferred embodiment of the present invention.

FIG. 7a is a schematic diagram illustrating a new left-eye brightness distribution according to one preferred embodiment of the present invention.

FIG. 7b is a schematic diagram illustrating a new right-eye brightness distribution according to one preferred embodiment of the present invention.

FIG. 8 is a block diagram illustrating a system for reducing ghost images of 3D images according to one preferred embodiment of the present invention.

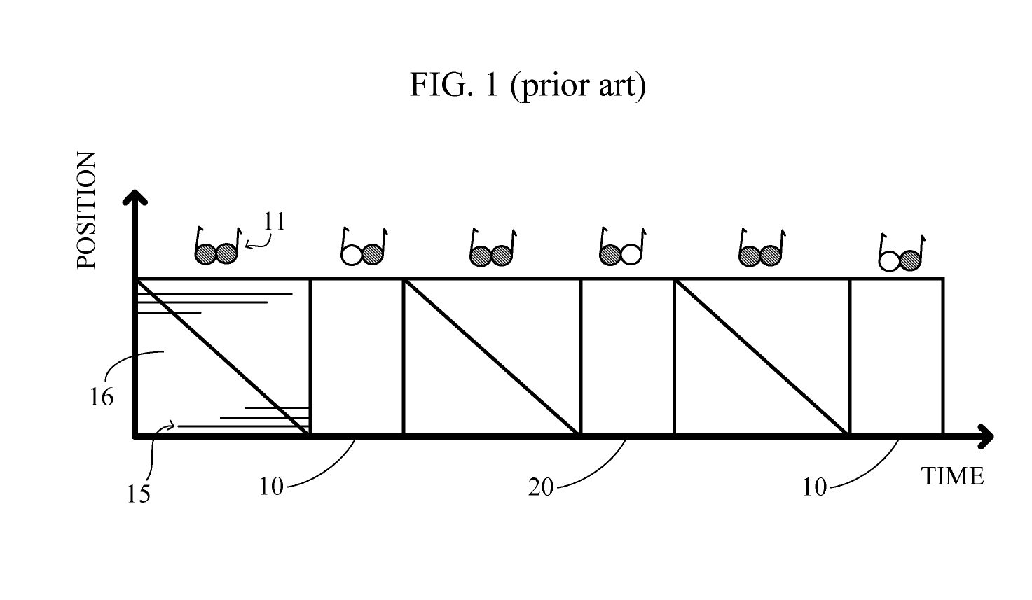

### DETAILED DESCRIPTION OF THE INVENTION

In one preferred embodiment, the method for reducing ghost images of 3D images observed from a screen with shutter glasses, thereby reducing a right-eye image observed by the left eye and a left-eye image observed by the right eye. The screen can be an LCD monitor, a projection display screen, or other display devices with a progressive scan. The shutter glasses accompany the liquid crystal to cover the eyes by control of light transmittance. The screen alternately displays the left-eye image and the right-eye image. The shutter glasses cover the right eye for the left eye to see the left-eye image when the screen displays the left-eye image; and the shutter glasses cover the left eye for the right eye to see the right-eye image when the screen displays the right-eye image.

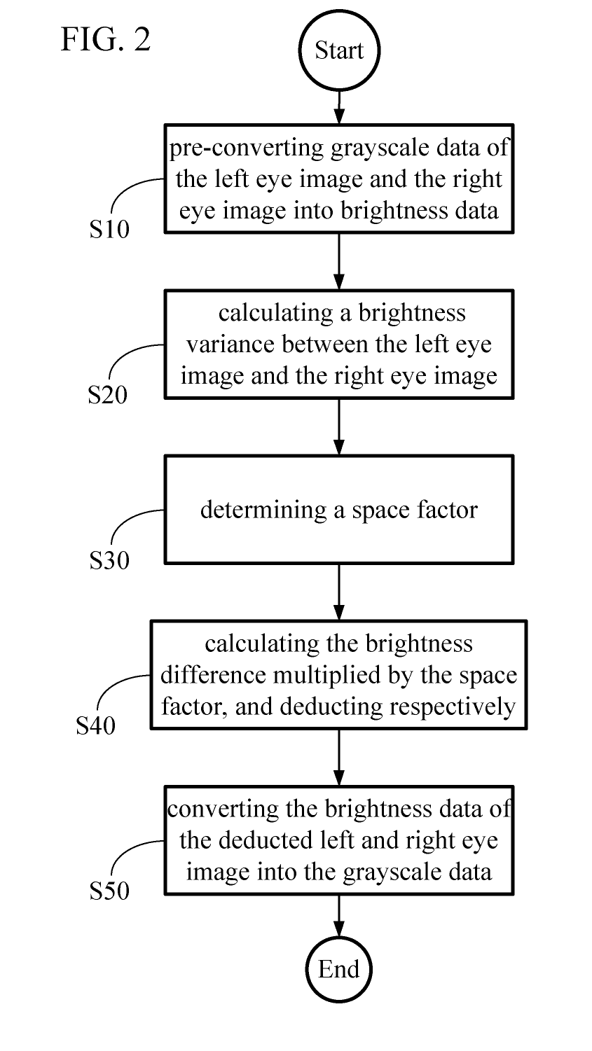

FIG. 2 is a flow chart illustrating a method for reducing ghost images of 3D images according to one preferred embodiment of the present invention. Referring to FIG. 2, the method for reducing ghost images of 3D images according to one preferred embodiment of the present invention comprises the steps S10 to S50.

At step S10, a first conversion unit is used to pre-convert grayscale data of a left-eye image and a right-eye image into brightness data. Because relationship between the grayscale data of each pixel of the screen and the brightness data is not linear, in addition, the human eyes can perceive the brightness of the images rather than the grayscale data of the pixels of the screen, the grayscale data of each pixel of the left-eye image and right-eye image shown on the screen should be converted as the brightness data. The first conversion unit can be implemented in a hardware device or software.

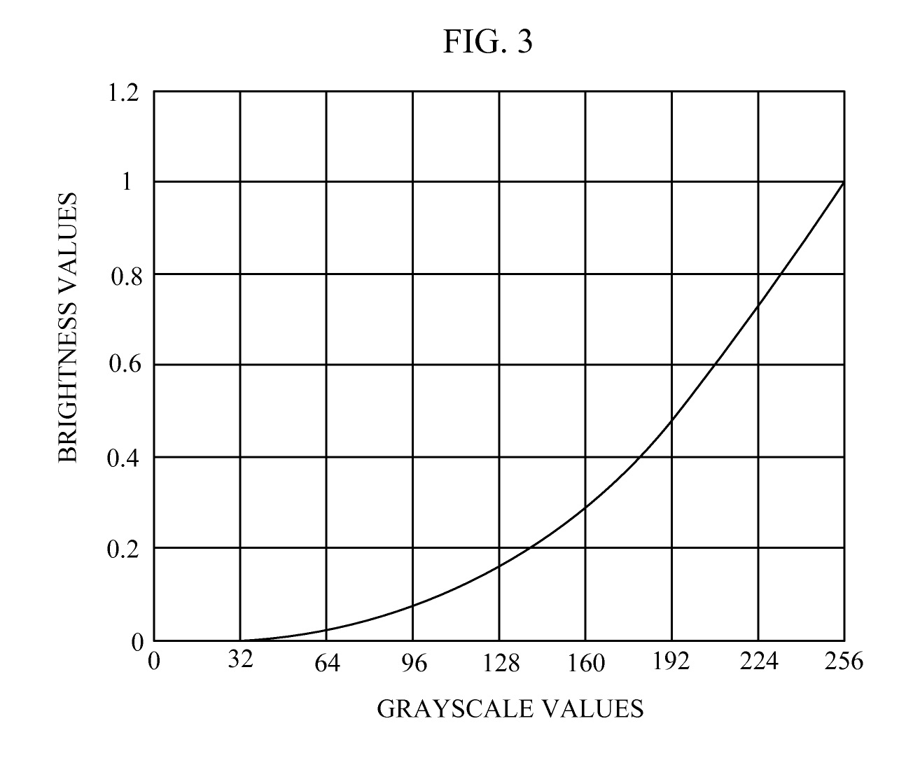

Moreover, the converting method can be implemented by using a look-up table or a formula computation. The look-up table is shown in FIG. 3. FIG. 3 is a schematic diagram illustrating a relationship between grayscale data and brightness data. The horizontal axis herein represents the grayscale values of a pixel, the grayscale values being between 0 and 255, and the vertical axis herein represents the brightness values between 0 and 1. Accordingly, the brightness data can be obtained from a predetermined grayscale value of the pixel of the screen in FIG. 3, thereby obtaining a more accurate brightness data. Besides, the brightness data can be obtained from a formula of gamma 2.2, whereby the formula has a brightness value=(grayscale value/255)̂2.2. The formula can be used to obtain the brightness data more quickly.

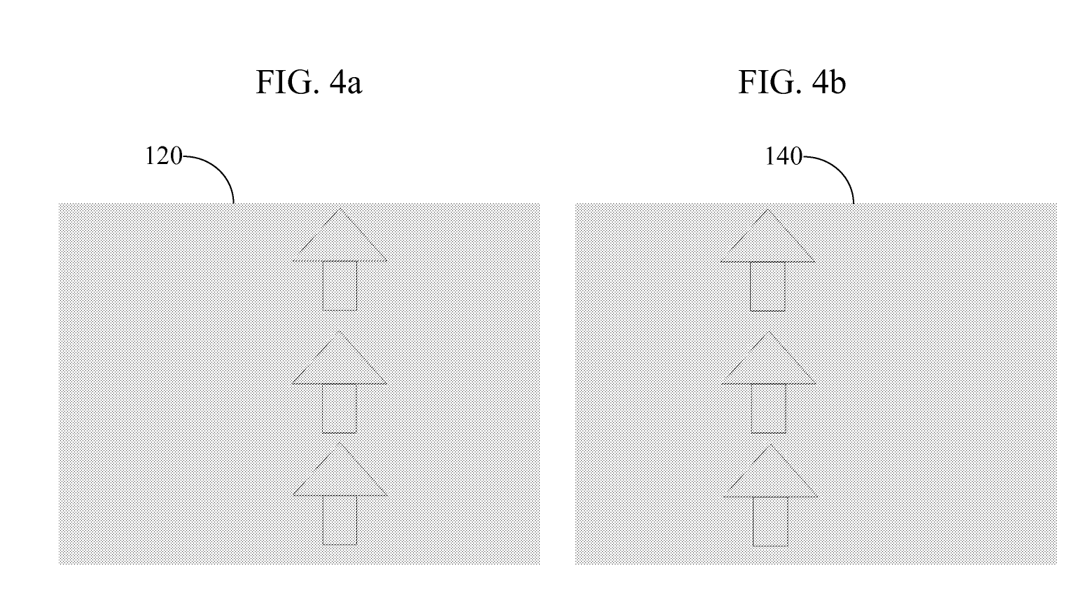

Referring to FIG. 4a and FIG. 4b, FIG. 4a is a schematic diagram illustrating a left-eye brightness distribution corresponding to a left-eye image according to one preferred embodiment of the present invention, and FIG. 4b is a schematic diagram illustrating a right-eye brightness distribution corresponding to a right-eye image according to one preferred embodiment of the present invention. In one preferred embodiment, the first conversion unit obtains the left-eye brightness distribution (hereinafter referred to as the left-eye brightness 120) and the right-eye brightness distribution (hereinafter referred to as the right-eye brightness 140) through the aforesaid converting method. It must be noted that a pixel comprises red, green, and blue sub-pixels, and each of the three sub-pixels has a grayscale value thereof. Thus, after conducting the aforesaid conversion method, the left-eye brightness 120 and the right-eye brightness 140 are actually colored pictures. In order to explain more clearly, the left-eye brightness 120 and the right-eye brightness 140 are represented as grayscale pictures in the drawings.

Since the ghost image occurs only in a position where a brightness difference distribution between the left-eye image and the right-eye image exists. Therefore, the brightness difference distribution should be calculated in advance after the step S10. At step S20, a first computing module is used to calculate the brightness difference distribution between the left-eye image and the right-eye image. Moreover, the step of calculating the brightness difference distribution between the left-eye image and the right-eye image can be divided into two sub-steps: first, calculating a right ghost brightness distribution (hereinafter referred to as the right ghost brightness) by subtracting a brightness distribution of the previous left-eye image from a brightness distribution of the current right-eye image ; second, calculating a left ghost brightness distribution (referred to as the left ghost brightness) by subtracting a brightness distribution of the previous right-eye image from a brightness distribution of the current left-eye image. An image representing the right ghost brightness is known as a right ghost image and an image representing the left ghost brightness is known as a left ghost image. The first computing module can be implemented by a hardware device or software.

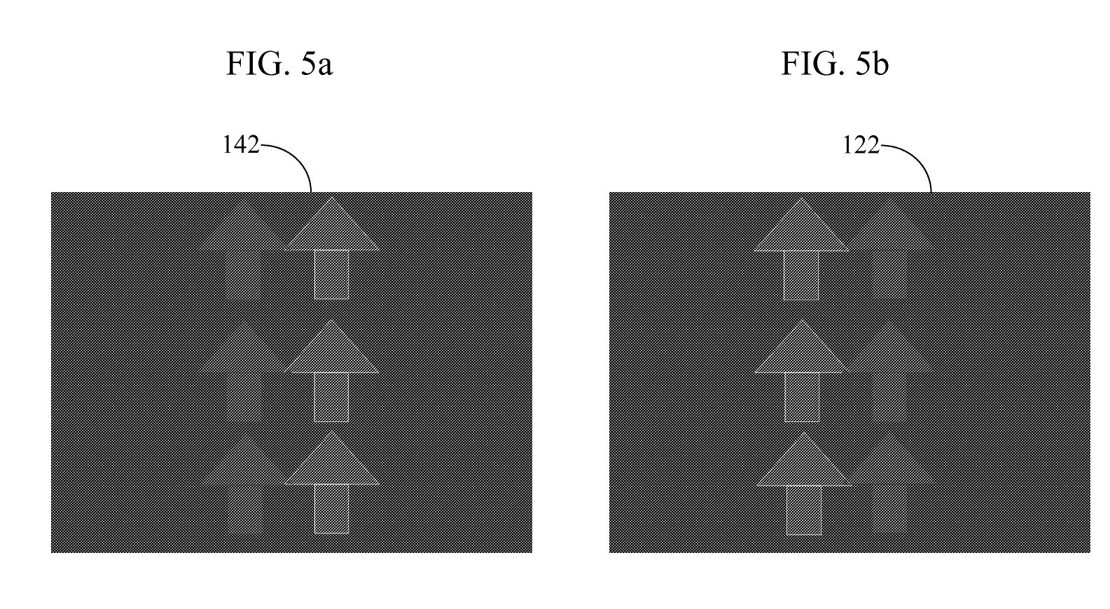

Referring to FIG. 5a and FIG. 5b, FIG. 5a is a schematic diagram illustrating a right ghost brightness distribution according to one preferred embodiment of the present invention, and FIG. 5b is a schematic diagram illustrating a left ghost brightness distribution according to one preferred embodiment of the present invention. The residual right-eye brightness 140 observed by the left eye is causing what is being referred to as a right ghost image, and it is due to the difference of the right-eye brightness from the left-eye brightness. Similarly, the residual left-eye brightness 120 observed by the right eye is causing what is being referred to as a left ghost image, and it is due to the difference between the left-eye brightness from the right-eye brightness. In other words, a brightness distribution of the left-eye image subtracted from a brightness of the right-eye image, that is, said pervious left-eye brightness 120 subtracted from said current right-eye brightness 140 will get a right ghost brightness 142 as shown in FIG. 5a. Similarly, a brightness distribution of the right-eye image subtracted from a brightness of the left-eye image, that is, said pervious right-eye brightness 140 subtracted from said current left-eye brightness 120 will get a left ghost brightness 122 as shown in FIG. 5b.

Due to the main causes of the ghost images from the background of the invention, that is, the transition of liquid crystal being not quick enough on a bottom of a LCD screen, the ghost image has various degrees between the bottom and top of the LCD screen. Thus, it needs to be corrected. At step S30 subsequent to step S20, a space factor module is used to determine a space factor, which represents a brightness change resulting from the brightness difference distribution on the left-eye image or the right-eye image, and the space factor is determined according to 2D positions where the brightness difference distribution occurs on the screen. Furthermore, the space factor represents that the brightness change of the right ghost brightness 142 on the left-eye brightness 120, which the brightness change herein is a residual image of the pervious right-eye image when the left eye observes the current left-eye image. Likewise, the space factor also represents that the brightness change of the left ghost brightness 122 on the right-eye brightness 140, which the brightness change herein is a residual image of the pervious left-eye image when the right eye observes the current right-eye image. In fact, because the left-eye image 120 and right-eye image 140 are alternately displayed on the same LCD screen, the transitions of the liquid crystals should be identical therebetween; that is, the space factor represents the brightness change of the brightness difference distribution in the left-eye brightness 120 or the brightness difference distribution in the right-eye brightness 140. Therefore, it is acceptable to get one of the brightness change of the right ghost brightness 142 on the left-eye brightness 120 or the brightness change of the left ghost brightness 122 on the right-eye brightness 140. The space factor module herein can be implemented in a hardware device or software.

The space factor varies according to 2D positions of the right ghost brightness 142 or the left ghost brightness 122 on the screen. In the preferred embodiment, the space factor changes with a vertical direction of the screen. The space factor changes with a linear variation; for instance, the least effect at the topmost of the screen can be assessed as 0%, and the highest effect at the bottommost of the screen can be assessed as 100%. In addition, the space factor further relates to characteristics of the LCD panel of the screen. The LCD panels produced by different manufacturers have different characteristics, for example, different types of liquid crystal molecules, different response time, and so on. Thus, in order to achieve a better correction of the 3D images, in addition to the linear variation, the space factor is further multiplied by a light leakage rate to compensate the characteristics of the LCD panels. The light leakage rate herein is at N%, where N is a positive integer between 1 and 100. The light leakage rate can be adjusted based on experiments for obtaining the best viewing.

At step S40 subsequent to step S30, a second computing module is used to multiply the brightness difference distribution by the space factor to obtain a compensated right ghost brightness distribution (hereinafter referred to as the compensated right ghost brightness) and a compensated left ghost brightness distribution (hereinafter referred to as the compensated left ghost brightness), and respectively deduct the compensated right ghost brightness and the compensated left ghost brightness from the left-eye image and the right-eye image.

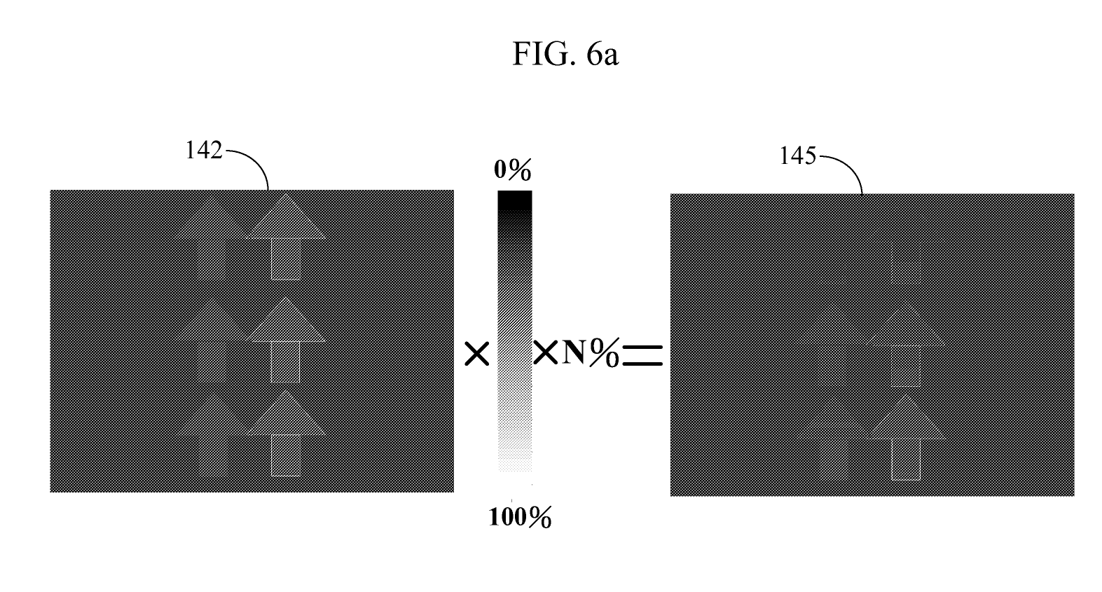

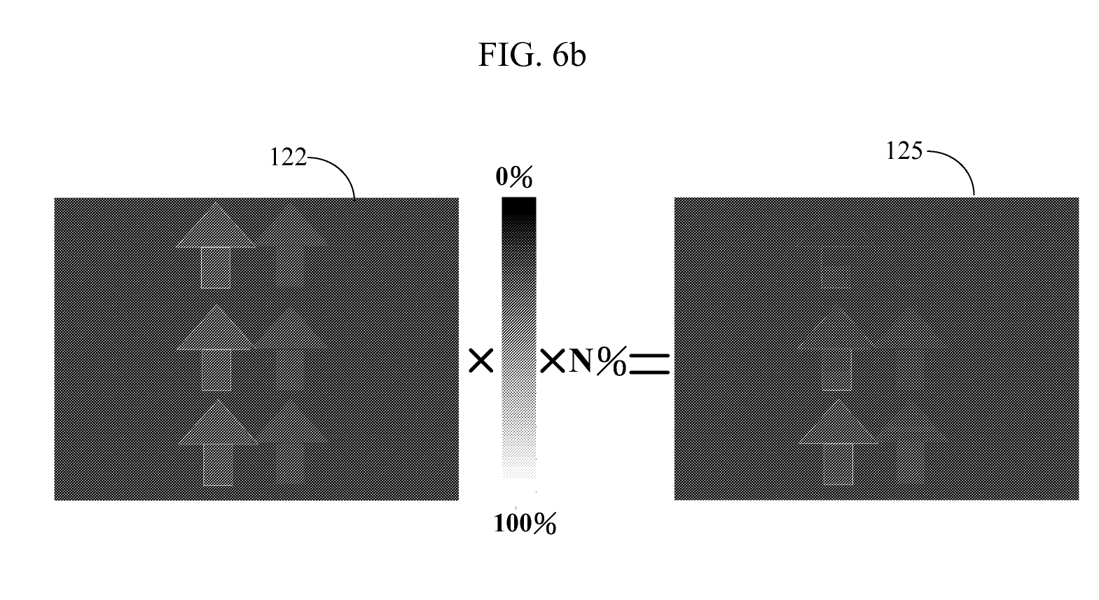

Referring to FIG. 6a and FIG. 6b, FIG. 6a is a schematic diagram illustrating calculating the compensated right ghost brightness according to one preferred embodiment of the present invention, and FIG. 6b is a schematic diagram illustrating calculating the compensated left ghost brightness according to one preferred embodiment of the present invention. In the preferred embodiment, the brightness difference distribution is the right ghost brightness 142 or the left ghost brightness 122. Referring to FIG. 6a, the second computing module calculates the right ghost brightness 142 multiplied by the space factor to get a compensated right ghost brightness 145. The space factor herein is the brightness data with vertical direction of the screen multiplied by the linear variation such as 0% to 100% multiplied by the light leakage rate N% (such as 15%). Likewise, referring to FIG. 6b, the second computing module calculates the left ghost brightness 122 multiplied by the space factor to get a compensated left ghost brightness 125.

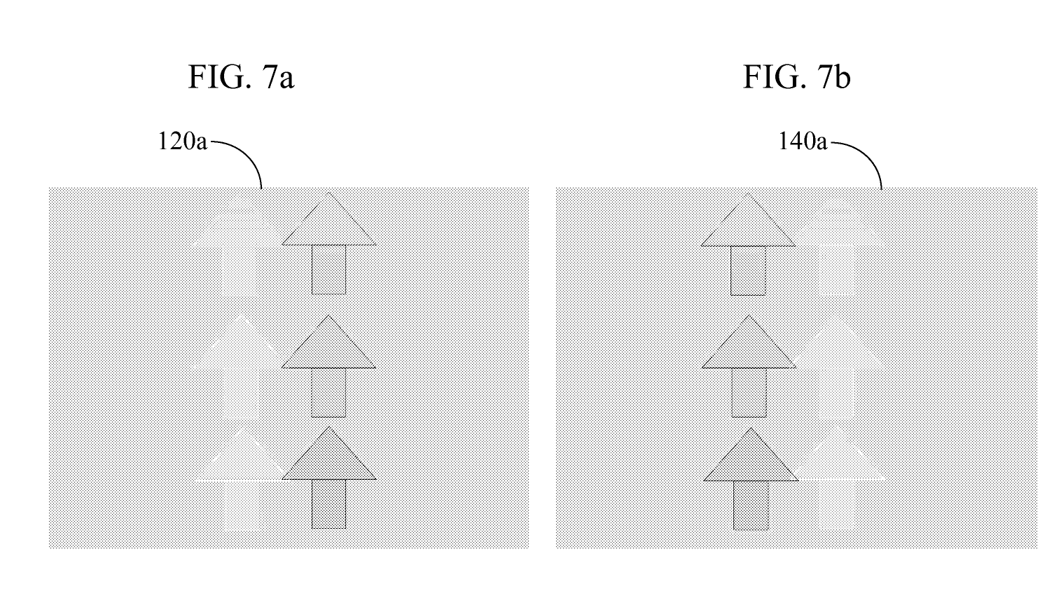

Referring to FIG. 7a and FIG. 7b, FIG. 7a is a schematic diagram illustrating a new left-eye brightness distribution (hereinafter referred to as the new left-eye brightness) according to one preferred embodiment of the present invention, and FIG. 7b is a schematic diagram illustrating a new right-eye brightness distribution (hereinafter referred to as the new right-eye brightness) according to one preferred embodiment of the present invention. After obtaining the compensated right ghost brightness 145 and the compensated left ghost brightness 125, the second computing module calculates the compensated right ghost brightness 145 deducted from the left-eye brightness 120 to get a new left-eye brightness 120a, and calculates the compensated left ghost brightness 125 deducted from the right-eye brightness 140 to get a new right-eye brightness 140a.

The method further comprises step S50: using a second conversion unit to convert the brightness data of the deducted left-eye image and right-eye image to the grayscale data after deducting the compensated right ghost brightness 145 and the compensated left ghost brightness 125 from the left-eye brightness 120 and the right-eye brightness 140 respectively. In the preferred embodiment, the brightness data of the new left-eye brightness 120a and the new right-eye brightness 140a are converted into the grayscale data. The second conversion unit which is similar to the first conversion unit will convert inversely, and the converting method can be implemented by using the Look-Up table or a formula computation. How to use the Look-Up table is described at step S10, and the formula computation utilizes the formula of gamma 2.2, which the formula is a grayscale value=(brightness value ̂0.4545)×255. The computed grayscale data of a new left-eye image and a new right-eye image are provided to display on the screen of the LCD monitor.

In accordance with the method for reducing ghost images of 3D images of the present invention, a negative signal of the compensating ghost images can be deducted in advance on the left-eye image and the right-eye image, thereby reducing the ghost images to solve the drawback of using the over-driven table with a limited effectiveness in the prior art and improving the viewing comfort.

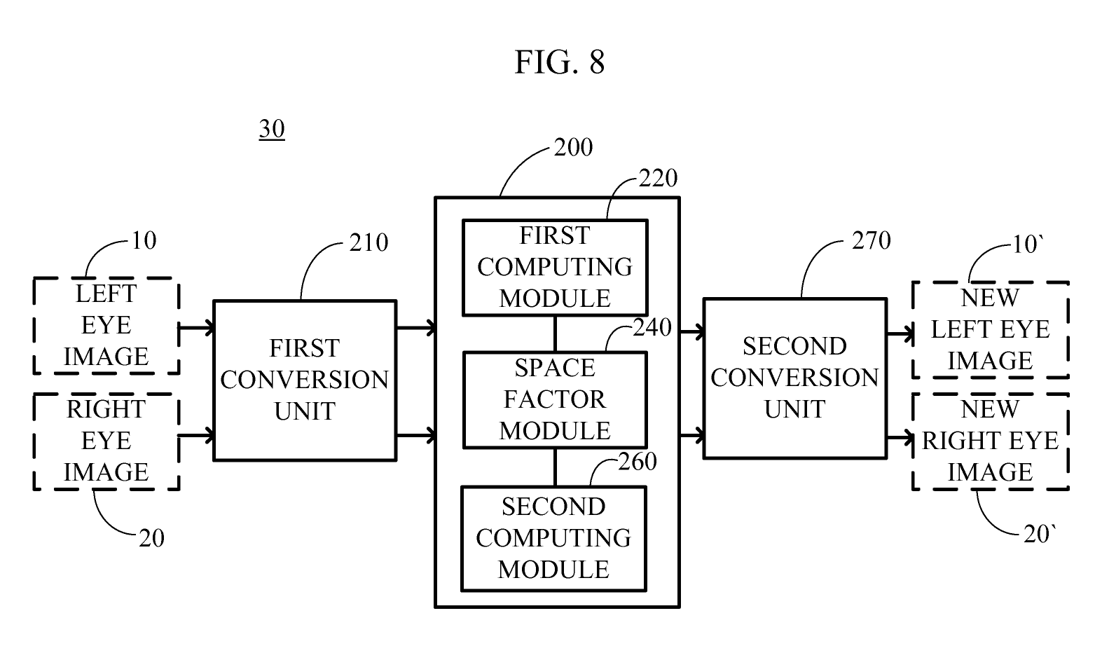

The present invention also provides a system for implementing aforesaid method for reducing ghost images of 3D images. The system for reducing ghost images of 3D images observed from a screen with shutter glasses, thereby reducing a right-eye image observed by a left eye and a left-eye image observed by a right eye observing. Referring to FIG. 8, FIG. 8 is a block diagram illustrating a system for reducing ghost images of 3D images according to one preferred embodiment of the present invention. The system 30 further comprises a first conversion unit 210, a ghost elimination module 200 and a second conversion unit 270.

In one preferred embodiment of the present invention, the first conversion unit 210, which is electrically coupled to the ghost elimination module 200 for receiving the left-eye image 10 and right-eye image 20, is utilized to pre-convert the grayscale data of the left-eye image 10 and the right-eye image 10 into the brightness data. The converting method can utilize the Look-Up table or the formula of gamma 2.2.

The ghost elimination module 200 is electrically coupled to the first conversion unit 210 and second conversion unit 270. The ghost elimination module 200 comprises a first computing module 220, a space factor module 240 and a second computing module 260. The ghost elimination module 200 can be implemented in a hardware device or software. Preferably, the hardware device is a circuit system disposed in the LCD panel of the screen, and the software is an image processing software.

The first computing module 220 is utilized to calculate a brightness difference distribution between the left-eye image and the right-eye image. For instance, according to the grayscale data of the left-eye image 10 and the right-eye image 20 converted by the first conversion unit 210, the first computing module 220 computes said right ghost brightness 142 and said left ghost brightness 122 as shown in FIG. 4a and FIG. 4b.

The space factor module 240 is utilized to determine a space factor which indicates a brightness change resulting from the brightness difference distribution on the left-eye image 10 or the right-eye image 20. The space factor is determined according to 2D positions where the brightness difference distribution occurs on the screen. For instance, according to the brightness change of the right ghost brightness 142 or the left ghost brightness 122 within said left-eye brightness 120 or said right-eye brightness 140, the space factor herein is the brightness data with vertical direction of the screen of the ghost images multiplied by the linear variation, that is, a factor between 0% to 100% multiplying by the light leakage rate N%.

The second computing module 260 is used to calculate the brightness difference distribution multiplied by the space factor for obtaining a compensated right ghost brightness 145 and a compensated left ghost brightness 125 as shown in FIG. 6a and FIG. 6b. The compensated right ghost brightness 145 and the compensated left ghost brightness 125 are respectively deducted from the grayscale data of the left-eye image 10 and the right-eye image 20 to obtain a new left-eye brightness 120a and a new right-eye brightness 140a.

The second conversion unit 270, which is electrically coupled to the second computing module 260 of the ghost elimination module 200, is utilized to convert the brightness data of the deducted left-eye image and the deducted right-eye image into the grayscale data. For instance, the new left-eye brightness 120a and the new right-eye brightness 140a are converted to the grayscale data for obtaining a new left-eye image 10′ and a new right-eye image 20′. The computed grayscale data of the new left-eye image 10′ and new right-eye image 20′ are provided to show on the screen of the LCD monitor (not shown) to reduce said ghost images.

In accordance with the system for reducing ghost images of 3D images of the present invention, the negative signal of the compensating ghost images can be deducted in advance on the left-eye image and the right-eye image, thereby countervailing the ghost images in actually viewing the 3D images for reducing a effect of the ghost images and improving the viewing comfort.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for reducing ghost images of three-dimensional (3D) images observed from a screen with shutter glasses, thereby reducing a right-eye image observed by a left eye and a left-eye image observed by a right eye observing, the method comprising:
using a first computing module to calculate a brightness difference distribution between the left-eye image and the right-eye image;
using a space factor module to determine a space factor indicating a brightness change resulting from the brightness difference distribution on the left-eye image or the right-eye image, the space factor being determined according to two-dimensional (2D) positions where the brightness difference distribution occurs on the screen; and
using a second computing module to multiply the brightness difference distribution by the space factor to obtain a compensated right ghost brightness and a compensated left ghost brightness, and respectively deducting the compensated right ghost brightness and the compensated left ghost brightness from the left-eye image and the right-eye image.

2. The method of claim 1, the method further comprising using a first conversion unit to pre-convert grayscale data of the left-eye image and the right-eye image into brightness data.

3. The method of claim 1, the method further comprising using a second conversion unit to convert the brightness data of the deducted left-eye image and the deducted right-eye image into the grayscale data after deducting the compensated right ghost brightness and the compensated left ghost brightness from the left-eye image and the right-eye image respectively.

4. The method of claim 1, wherein the brightness difference distribution between the left-eye image and the right-eye image is a left ghost brightness whereby a brightness of the right-eye image subtracting from a brightness of the left-eye image, and a right ghost brightness whereby a brightness of the left-eye image subtracting from a brightness of the right-eye image.

5. The method of claim 1, wherein the space factor changes in a vertical direction of the screen.

6. The method of claim 5, wherein the space factor changes in a linear variation.

7. The method of claim 6, wherein the space factor is a light leakage rate multiplying the linear variation between 0 and 1.

8. The method of claim 7, wherein the light leakage rate relates to characteristics of an LCD panel of the screen.

9. A system for reducing ghost images of three-dimensional (3D) images observed from a screen with shutter glasses, thereby reducing a right-eye image observed by a left eye and a left-eye image observed by a right eye observing, the system comprising:
a first computing module for calculating a brightness difference distribution between the left-eye image and the right-eye image;
a space factor module for determining a space factor indicating a brightness change resulting from the brightness difference distribution on the left-eye image or the right-eye image, the space factor being determined according to two-dimensional (2D) positions where the brightness difference distribution occurs on the screen; and
a second computing module for multiplying the brightness difference distribution by the space factor to obtain a compensated right ghost brightness and a compensated left ghost brightness, and respectively deducting the compensated right ghost brightness and the compensated left ghost brightness from the left-eye image and the right-eye image.

10. The system of claim 9, the system further comprising:
a first conversion unit electrically coupled to the first computing module of the ghost elimination module for pre-converting grayscale data of the left-eye image and the right-eye image into brightness data; and
a second conversion unit electrically coupled to the second computing module of the ghost elimination module for converting the brightness data of the deducted left-eye image and the deducted right-eye image into the grayscale data.
